(19) United States
(12) Patent Application Publication
(10) Pub. No.: US 2011/0238472 A1
(43) Pub. Date: Sep. 29, 2011

(54) STRATEGIC MARKETING SYSTEMS AND METHODS

(75) Inventor: Gururaj Sunkada, Bangalore (IN)

(73) Assignee: VERIZON PATENT AND LICENSING, INC., Basking Ridge, NJ (US)

(21) Appl. No.: 12/732,548

(22) Filed: Mar. 26, 2010

(51) Int. Cl. G06Q 30/00; G06Q 50/00

(52) U.S. Cl. 705/14.23

(57) ABSTRACT

Exemplary strategic marketing systems and methods are disclosed herein. An exemplary method includes a strategic marketing subsystem receiving, from an advertiser subsystem, data representative of an offer for sale of a product, the offer specifying a price discount conditioned on a participation requirement, delivering the offer to a plurality of users, receiving one or more orders for the product by one or more of the users, grouping the one or more users into a group based on the one or more orders and on at least one of the price discount and the participation requirement, determining whether the group satisfies the participation requirement, and sending data representative of the group to the advertiser subsystem for use in fulfillment of the one or more orders in response to a determination that the group satisfies the participation requirement. Corresponding methods and systems are also disclosed.

### BACKGROUND INFORMATION

As media content distribution and processing technologies have advanced, media outlets through which media content is distributed have increased both in number and type. The increased numbers and types of media outlets have provided a variety of platforms that may be used by advertisers to distribute advertising content to potential consumers.

However, a number of disadvantages exist for advertisers who utilize media outlets for distribution of advertising content and for potential consumers who receive the advertising content via the media outlets. For example, conventional media-outlet-based advertising is focused on consumers as individuals. This is due at least in part to efforts to target advertisements based on individual interests, purchasing histories, and/or preferences. Because of such focus on the individual consumer, advertising content distributed to potential consumers via one or more media outlets is traditionally limited to content that is based solely on advertiser expectations that the advertising content will be considered and either accepted or rejected on an individual basis. Accordingly, potential consumers do not have opportunity to receive, consider, and either accept or reject advertising content such as advertisement offers that are structured for groups of potential consumers to pursue jointly. In addition, advertisers offering only individual-based advertisements cannot benefit from additional revenue that could potentially result from group participation in group-based advertisement offers.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers may designate identical or similar elements.

FIG. 1 illustrates an exemplary strategic marketing system according to principles described herein.

FIG. 2 illustrates exemplary components of a strategic marketing subsystem according to principles described herein.

FIG. 3 illustrates an exemplary strategic marketing method according to principles described herein.

FIG. 4 illustrates an exemplary graphical user interface (“GUI”) through which an advertiser can create a strategic marketing campaign according to principles described herein.

FIG. 5 illustrates an exemplary strategic marketing campaign offer according to principles described herein.

FIG. 6 illustrates exemplary mobile phone users associated with closed user group (“CUG”) users according to principles described herein.

FIG. 7 illustrates an exemplary flow of advertisements to CUG users according to principles described herein.

FIG. 8 illustrates an exemplary GUI through which a user may submit an order in response to a strategic marketing campaign offer according to principles described herein.

FIG. 9 illustrates an exemplary GUI through which information regarding multiple offers may be displayed to a user according to principles described herein.

FIG. 10 illustrates an exemplary grouping of users into a user group according to principles described herein.

FIG. 11 illustrates an exemplary grouping of users into a plurality of user groups according to principles described herein.

FIG. 12 illustrates an exemplary GUI within which information regarding one or more strategic marketing campaign offers may be displayed to an advertiser according to principles described herein.

FIG. 13 illustrates another exemplary strategic marketing method according to principles described herein.

FIG. 14 illustrates an exemplary computing device according to principles described herein.

### DETAILED DESCRIPTION OF PREFERRED EMBODIMENTS

Exemplary strategic marketing systems and methods are disclosed herein. As described further below, one or more of the exemplary systems and/or methods disclosed herein may enable an advertiser and/or potential consumers to leverage predefined and/or dynamically formed groups of potential consumers to increase the effectiveness, expand the types, and/or expand the audience of advertising content distributed via one or more media distribution platforms.

As an example, one or more of the exemplary systems and methods disclosed herein may include a strategic marketing subsystem that receives data representative of an offer from an advertiser subsystem and delivers data representative of the offer to a plurality of access devices associated with a plurality of users. The offer may specify a price discount and a corresponding participation requirement (e.g., a minimum number of orders or users required to qualify for the price discount). The strategic marketing subsystem may receive data representative of one or more orders for the product from one or more users in response to the offer, group (e.g., based on the orders, the price discount, participation requirement, etc.) the one or more users into a group, and determine whether the group satisfies the corresponding participation requirement. When the group is determined to satisfy the corresponding participation requirement, the strategic marketing subsystem may send data representative of the group to the advertiser subsystem for use in fulfillment of the one or more orders. In this or a similar manner, a user base of one or more media content distribution platforms may be leveraged to dynamically identify and group one or more of the users who are interested in an offer such that the group of users may qualify for a price discount offered by an advertiser.

In certain embodiments, the strategic marketing subsystem may harness social influence among multiple users by identifying and delivering an offer to a plurality of users associated with a predefined user group. As a result, the strategic marketing subsystem may influence purchasing patterns among the users. For example, the strategic marketing subsystem may identify and deliver the offer to a plurality of mobile phone users associated with each other through one or more closed user groups (“CUGs”). The mobile phone users within the closed user groups may influence each other's decision to submit an order in response to the offer. For example, in order to satisfy the participation requirement of the offer, some users within the closed user groups may convince other users within the closed user groups to submit orders. Accordingly, the strategic marketing subsystem may leverage social influence within a predefined user group to increase the number of orders received in response to a particular offer.

Components and functions of exemplary strategic marketing systems and methods will now be described with reference to the drawings.

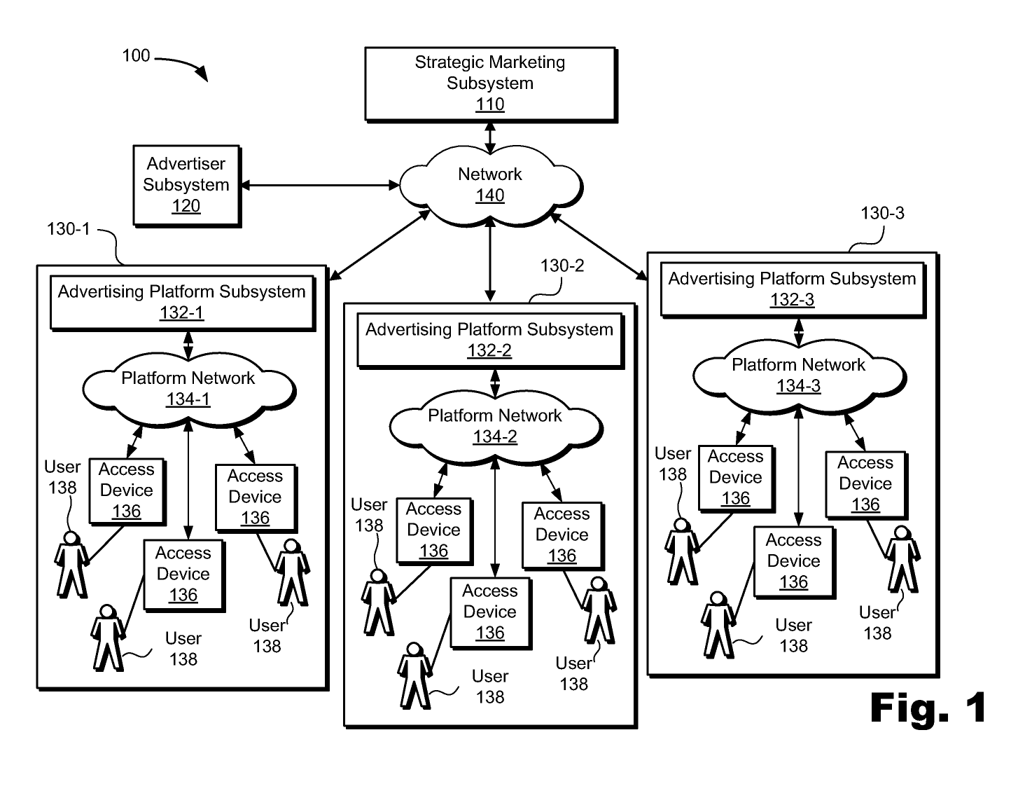

FIG. 1 illustrates an exemplary computing system 100 (or simply “system 100”) configured to perform various steps according to principles described herein. As shown in FIG. 1, system 100 may include a strategic marketing subsystem 110 (or simply “marketing subsystem 110”) communicatively coupled to an advertiser subsystem 120 and a plurality of distinct, heterogeneous advertising platforms 130-1, 130-2, and 130-3 (collectively referred to herein as “advertising platforms 130”). In particular, marketing subsystem 110 may be communicatively coupled with a plurality of advertising platform subsystems 132-1, 132-2, and 132-3 (collectively referred to herein as “advertising platform subsystems 132” or simply “platform subsystems 132”), which may communicate with a plurality of access devices 136 associated with a plurality of users 138 via a plurality of respective platform networks 134-1, 134-2, and 134-3 (collectively referred to herein as “platform networks 134”).

Components of system 100 may communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

Components of system 100 may communicate using any suitable networks. For example, as shown in FIG. 1, components of system 100 may be configured to communicate with each other over a network 140 and/or platform networks 134 associated with respective advertising platforms 130. Network 140 and/or platform networks 134 may include one or more networks or types of networks capable of carrying communications and/or data signals between the components of system 100. For example, network 140 and/or platform networks 134 may include, but are not limited to, a cable network, an optical fiber network, a hybrid fiber coax network, a wireless network (e.g., a Wi-Fi and/or mobile telephone network), a satellite network, a wireless broadcast network (e.g., a satellite media broadcasting network or terrestrial broadcasting network), a subscriber television network, a provider-specific network (e.g., a Verizon® FIOS® network), the Internet, an intranet, local area network, any other suitable network, and/or any combination or sub-combination of these networks. In some examples, platform network 134-1 may be a first type of network (e.g., a mobile telephone service network), platform network 134-2 may be a second type of network different from platform network 134-1 (e.g., a television service network), and platform network 134-3 may be a third type of network different from platform networks 134-1 and 134-2 (e.g., an Internet service network).

While FIG. 1 shows components of system 100 communicatively coupled via network 140 and platform networks 134, it will be recognized that the components of system 100 may be configured to communicate one with another in any other suitable manner (e.g., via a direct connection).

In some examples, marketing subsystem 110 and/or advertiser subsystem 120 may be configured to generate or otherwise provide (e.g., as part of a marketing or promotional campaign) an offer for sale of a product to access devices 136. In certain embodiments, marketing subsystem 110 may be configured to receive data representative of the offer from advertiser subsystem 120 for distribution to one or more access devices 136. The offer may include any text, audio, video, image(s), photograph(s), document(s), application file(s), or any segment, component, or combination of these or any other data representative of an offer for sale of a product to users 138. As used herein, the term “product” may refer to any good, service, information, or other tangible or intangible product being offered for sale.

The offer may also be associated with an advertisement (also referred to herein as an “ad” or “advertisement asset”) configured to accompany or convey the offer to a user. Examples of advertisements that may be associated with the offer may include, without limitation, linear advertisements, on-demand advertisements (e.g., video-on-demand (“VOD”) advertisements), interactive advertisements, banner advertisements, application insertion advertisements, and content portal advertisements. Linear advertisements may include traditional commercials (e.g., thirty-second spots) within a media content broadcast and/or multicast channel (e.g., a commercial within a television broadcast or multicast channel). On-demand advertisements may include advertisements housed within an on-demand system (e.g., one or more on-demand content servers), such as VOD ads housed within one or more VOD servers. Interactive advertisements may include any advertisements with which a user may interact. Banner advertisements may include any advertisements that may be spatially placed within a display view provided to a user. Banner advertisements may include static and/or clickable banner ads. Application insertion advertisements may include advertisements that may be inserted within an application such as a video game application provided by a media outlet. The advertisement types described above are illustrative only. Other advertisement types and/or combinations of advertisement types may be used in other embodiments.

Marketing subsystem 110 may be configured to deliver an offer to one or more access devices 136. In certain examples, marketing subsystem 110 may deliver the offer directly to one or more access devices 136 through network 140 and/or platform networks 134. Additionally or alternatively, marketing subsystem 110 may be configured to deliver the offer to one or more advertising platform subsystems 132, which may deliver the offer and any associated advertisement directly to one or more access devices 136. To this end, strategic marketing subsystem 110 may be configured to communicate with advertising platform subsystems 132 (e.g., one or more server devices or other computing devices within advertising platforms 130) to leverage one or more advertising platforms 130 to facilitate delivery of the offer to one or more access devices 136 via the advertising platforms 130.

Advertising platforms 130 may operate distinctly and/or independently of one another. In particular, each advertising platform 130 may be associated with a particular advertising platform subsystem 132, a particular advertising platform network 134, and/or a number of particular access devices 136 associated with a number of users 138, independent of any other advertising platform 130. Accordingly, each of advertising platform subsystems 132 may perform one or more advertising platform processes and/or operations independently of the advertising platform processes and/or operations performed by the other advertising platform subsystems 132. For instance, each of the advertising platform subsystems 132 may distribute offers and/or advertisements independently of the other advertising platform subsystems 132. In certain embodiments, the independence of the advertising platform subsystems 132 may also include physical and/or logical separation of the advertising platform subsystems 132.

Advertising platforms 130, and the components thereof, may be heterogeneous. For example, advertising platforms 130 may be heterogeneous in one or more of the following ways: each advertising platform 130 may be associated with a distinct type of advertisement, each advertising platform 130 may associated with a distinct type of access device 136, and/or each advertising platform 130 may be associated with a distinct media distribution platform (e.g., television, mobile phone, Internet service platforms). Advertising platforms 130 may be heterogeneous in any of a number of additional or alternative ways. The examples of advertising platforms 130 described herein are illustrative only and not limiting in any sense. Other combinations of independent and/or heterogeneous advertising platforms may be employed to deliver offers and/or advertisements to users 138 in other embodiments. Such combinations may include any combinations and/or sub-combinations of the exemplary advertising platforms 130 described herein.

Advertising platform subsystems 132 may include one or more computing devices configured to perform one or more of the processes or steps described herein. In some examples, each advertising platform subsystem 132 may include a server associated with its respective advertising platform 130 and configured to communicate with its respective access devices 136. In certain embodiments, advertiser platform subsystems 132 and/or access devices 136 may include an agent or application of the strategic marketing subsystem 110 running on the platform subsystems 132 and/or access devices 136 and configured to perform one or more of the steps described herein.

Access devices 136 may be configured to receive, display, and/or otherwise access an offer generated or delivered by marketing subsystem 110 or advertiser subsystem 132. For example, access devices 136 may be configured to display, play, or otherwise present the offer to the user 138. An exemplary access device 136 may include, but is not limited to, a set-top-box device, a digital video recorder (“DVR”) device, a media content processing device, a communications device, a mobile device (e.g., a mobile phone device), a handheld device, a personal computer, a phone device, a personal-digital assistant device, a gaming device, a television device, and/or any device configured to perform one or more of the access device processes and/or operations described herein.

Advertiser subsystem 120 may include one or more computing devices configured to perform one or more of the processes or steps described herein. In some examples, advertiser subsystem 120 may include a computing device associated with an advertiser and configured to provide the advertiser with access to strategic marketing subsystem 110, such as through a web-based interface. The computing device may also include an agent or application associated with strategic marketing subsystem 110 and configured to perform one or more of the steps described herein.

While an exemplary system 100 is shown in FIG. 1, the exemplary components illustrated in FIG. 1 are not intended to be limiting. Other hardware environments and implementations may be used in other implementations. Exemplary components of system 100 will now be described in additional detail.

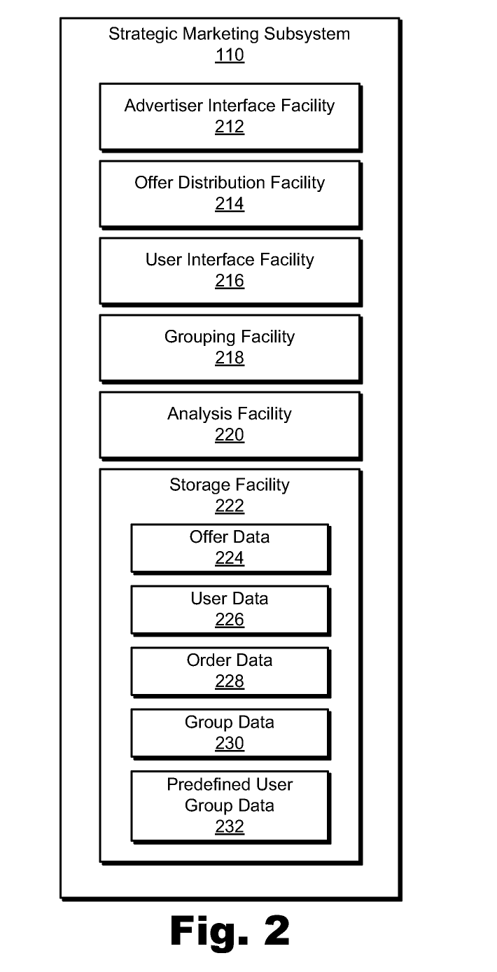

FIG. 2 illustrates exemplary components of strategic marketing subsystem 110. As shown in FIG. 2, strategic marketing subsystem 110 may include an advertiser interface facility 212, an offer distribution facility 214, a user interface facility 216, a grouping facility 218, an analysis facility 220, and a storage facility 222 communicatively coupled to one another. The components of strategic marketing subsystem 110 may communicate with one another, including sending data to and receiving data from one another, using any suitable communication technologies.

Advertiser interface facility 212 may be configured to provide an interface supporting communications with advertiser subsystem 120 and/or an advertiser operating advertiser subsystem 120. Accordingly, advertiser interface facility 212 may receive data associated with an offer for sale of a product from advertiser subsystem 120 and may provide data associated with the offer to advertiser subsystem 120. In certain embodiments, the advertiser interface provided by advertiser interface facility 212 may include a portal and/or a graphical user interface (“GUI”) accessible by advertiser subsystem 120. The portal and/or GUI may provide one or more tools for use by an advertiser. Such tools may include tools configured to facilitate creation of an offer, submission of the offer for distribution, and/or tracking of the status of an offer.

Offer distribution facility 214 may be configured to deliver data representative of an offer to one or more access devices 136 associated with one or more users 138. In certain embodiments, offer distribution facility 214 may be configured to identify a predefined user group including a plurality of users based on one or more criteria and distribute the offer to the identified predefined user group. For example, offer distribution facility 214 may identify a plurality of users associated with a closed user group (“CUG”) based on information received from grouping facility 218 and distribute an offer to each of the identified CUG users. Offer distribution facility 214 may abstain from delivering the offer to users who are not part of the CUG.

User interface facility 216 may be configured to facilitate communications between strategic marketing subsystem 110 and one or more users. For example, user interface facility 216 may provide an interface for communicating with users 138 and/or access devices 136. User interface facility 216 may be configured to receive data representative of one or more orders for a product placed by one or more users 138 to which an offer for sale of the product was delivered. In certain embodiments, user interface facility 216 may be configured to deliver information related to one or more offers available to users 138 to access devices 136 associated with the users 138. Accordingly, user interface facility 216 may facilitate the transfer of up-to-date information between users 138 and strategic marketing subsystem 110. In some examples, user interface facility 216 may be configured to provide one or more tools (e.g., a portal and/or a GUI) to a user 138. The tools may be configured to facilitate delivery of information related to an offer (e.g., the number of orders remaining until a participation requirement is satisfied) to the user and/or to facilitate the placing of an order by the user.

Grouping facility 218 may be configured to perform one or more grouping operations, which may enable an advertiser and/or users such as potential consumers to leverage predefined and/or dynamically formed groups of users to increase the effectiveness, expand the types, and/or expand the audience of product sales offers and/or advertisements that may be distributed via one or more media distribution platforms.

As an example, as described in more detail further below, grouping facility 218 may be configured to dynamically group data representative of one or more users into a group based on one or more orders placed by the one or more users for a product and on at least one of a price discount and a corresponding participation requirement specified by an offer for sale of the product. For instance, grouping facility 218 may be configured to automatically group users that place an order for a product into a group. Grouping facility 218 may further define the group based on a particular price discount and/or a corresponding participation requirement. The grouping may be performed in a manner that is designed to maximize the price discount awarded to the users based on the participation requirement and the number of users who have placed orders for the product.

As another example, as described in more detail further below, grouping facility 218 may receive data representative of one or more predefined user groups from the advertiser subsystem 120 and/or one or more of the advertising platform subsystems 132 and maintain the data for use in identifying predefined user groups to which an offer is to be delivered. Accordingly, offer distribution facility 214 may deliver the offer to select users included in one or more predefined user groups in accordance with data maintained by grouping facility 218. This may allow an advertiser to leverage one or more predefined user groups, as they have been defined in advertising platforms 130, and social relationships between users included in the predefined user groups to market a product.

Analysis facility 220 may be configured to determine whether a group of users determined by grouping facility 218 satisfies a corresponding participation requirement. In some examples, analysis facility 220 may compare the number of users in the group or the number of orders placed by the users in the group with the corresponding participation requirement. From this comparison, analysis facility 220 may determine whether the group satisfies the participation requirement. As described in more detail further below, when analysis facility 220 determines that the group satisfies the participation requirement, advertiser interface facility 212 may be configured to send data representative of the group to advertiser subsystem 120 for use in fulfillment of the orders placed by the users included in the group. Based on the satisfaction of the participation requirement by the group, the orders may be fulfilled at the discount price corresponding to the participation requirement.

Storage facility 222 may be configured to maintain offer data 224, user data 226, order data 228, group data 230, and/or predefined user group data 232. Offer data 224 may include data representative of one or more offers including data representative of corresponding products offered for sale, price discount levels, participation requirement levels, offer time frames (e.g., offer expiration dates), and any other information associated with offers to sale products. User data 226 may include data representative of users 138, such as data related to user access devices 136, predefined groups with which users 138 are associated (e.g., closed user groups, social networking groups, etc.), past purchases by users (e.g., orders placed by users in response to previous offers), user preferences, advertising platforms with which users are associated (e.g., a mobile phone service platform), and/or any other user data (e.g., user billing information). Order data 228 may include data representative of orders placed by users in response to offers. Group data 230 may include data representative of groups of users that are dynamically formed by grouping facility 218, such as groups of users formed based on orders placed by the users and on price discount levels and/or participation requirements specified by offers. Predefined user group data 232 may be received and maintained by grouping facility 218, as described above. Storage facility 222 may be configured to maintain additional or alternative data as may serve a particular application.

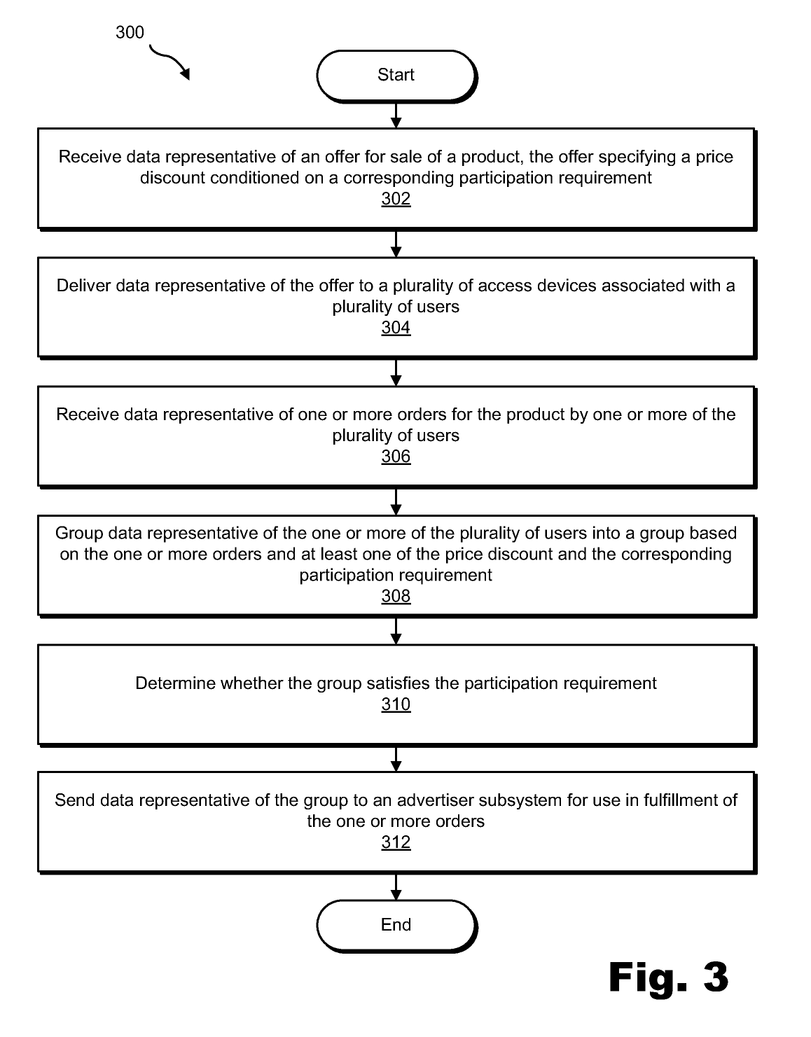

FIG. 3 illustrates an exemplary strategic marketing method 300. While FIG. 3 illustrates exemplary steps according to one embodiment, other embodiments may omit, add to, reorder, and/or modify any of the steps shown in FIG. 3. One or more of the steps shown in FIG. 3 may be performed by any component or combination of components of system 100.

In step 302, data representative of an offer for sale of a product may be received. The offer may specify a price discount conditioned on a corresponding participation requirement. The data representative of the offer may be received by advertiser interface facility 212 in any suitable manner. For example, the data representative of the offer may be received by way of a GUI provided by the advertiser interface facility 212.

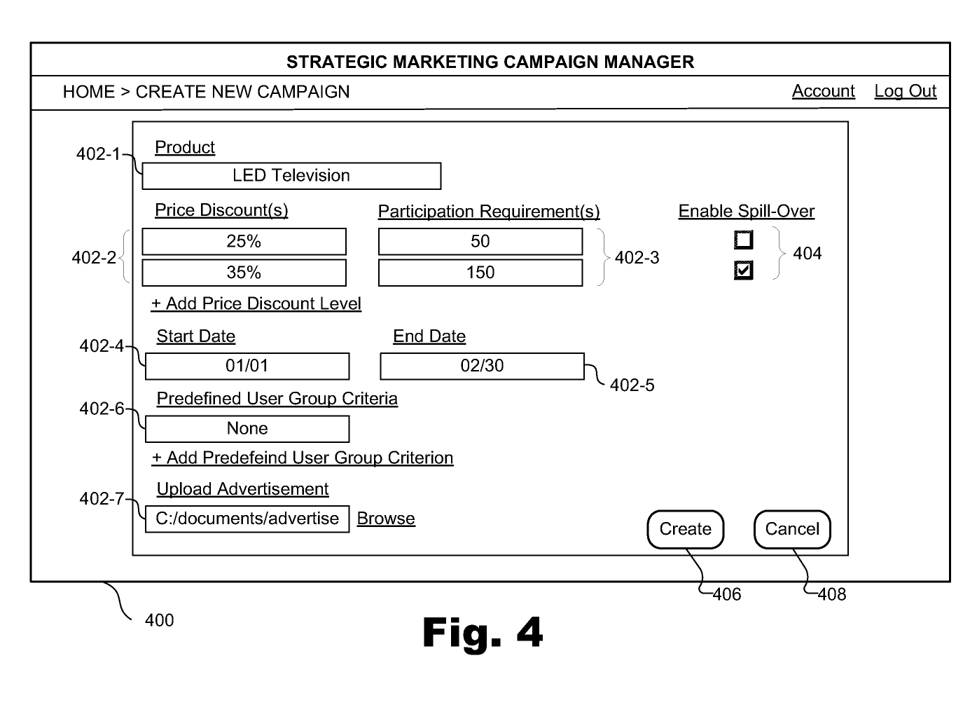

FIG. 4 illustrates an exemplary GUI 400 that may be provided by advertiser interface facility 212 and that may be configured to facilitate generation by an advertiser of a strategic marketing campaign including an offer for sale of a product, the offer specifying a price discount conditioned on a participation requirement. GUI 400 may be presented to the advertiser in any suitable manner as may serve a particular implementation. For example, GUI 400 may be presented to the user in a web browser as part of a web-based application configured to allow the advertiser to generate the offer using a computing device, and/or in any other suitable manner.

As shown in FIG. 4, a plurality of editable fields 402-1 through 402-7 (referred to collectively herein as “fields 402”), each associated with one or more parameters of an offer for sale of a product, may be displayed within GUI 400. GUI 400 shows seven fields 402 for illustrative purposes only. It will be recognized that any number of fields 402 and any number of associated offer parameters may be displayed within GUI 400 as may serve a particular implementation. GUI 400 may also include selectable options (e.g., options 404, 406, and 408) configured to allow an advertiser to enable or disable one or more features of the offer, create the offer, or cancel the offer.

The advertiser may enter a name or other description of the product to be sold in field 402-1. The advertiser may enter one or more price discounts for the offer in field 402-2 and one or more corresponding participation requirements in field 402-3. The advertiser may enter a start date and end date for the offer in fields 402-4 and 402-5, respectively. The advertiser may specify one or more predefined user group criteria in field 402-6 for identifying a predefined user group to which the offer will be distributed. Accordingly, the offer may be distributed only to users that satisfy the predefined user group criteria. The advertiser may utilize field 402-7 to upload a file (e.g., an advertisement) to be utilized as part of the marketing campaign.

To illustrate, an advertiser may access and utilize GUI 400 to create and initiate a marketing campaign to offer LED televisions for sale. Using GUI 400, the advertiser may indicate a willingness to provide a 25% price discount on the purchase of the LED televisions if at least 50 LED televisions are ordered as part of the marketing campaign, and a 35% price discount on the purchase of the LED televisions if at least 150 LED televisions are ordered as part of the marketing campaign. The advertiser may choose to enable or disable a spillover option indicating whether automatic spillover of participating users into new groups is to be performed as the corresponding participation requirement has been satisfied. As further illustrated in FIG. 4, the advertiser may indicate in GUI 400 a desire to limit the marketing campaign and/or price discounts to a specific time period (e.g., January 1^{st} through February 28^{th}) and to place no predefined user group restrictions on recipients of the offer. The advertiser may also upload data representative of an advertisement to be associated with the marketing campaign. As will be described in more detail below, the data inputted into the GUI 400 by the advertiser may be utilized by offer distribution facility 214, user interface facility 216, grouping facility 218, and analysis facility 220 to execute the marketing campaign. Once the marketing campaign is generated, data representative of the marketing campaign may be stored and maintained as offer data 224 in storage facility 222.

Returning to FIG. 3, in step 304, data representative of the offer may be delivered to a plurality of access devices associated with a plurality of users. For example, offer distribution facility 214 may initiate delivery of the offer to one or more access devices 136. The data representative of the offer may be delivered to the plurality of access devices in any suitable manner, including in any of the ways described herein.

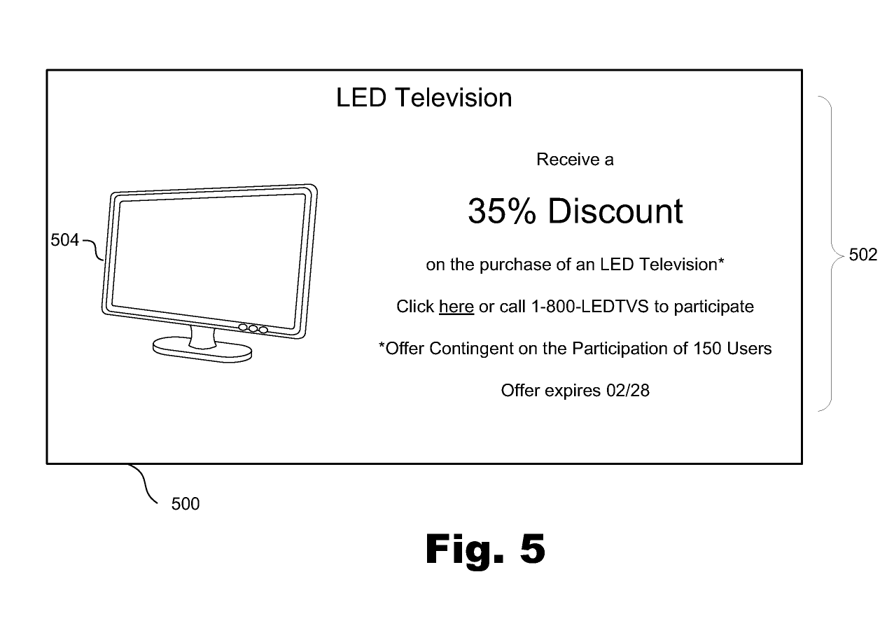

In some examples, the offer may be detailed in or accompanied by an advertisement. FIG. 5 illustrates an exemplary advertisement 500 according to principles described herein. As shown, advertisement 500 may include text 502 setting forth one or more parameters and/or conditions of the offer being delivered and one or more images 504 illustrating one or more features related to the product being offered for sale. Advertisement 500 may convey any of the information provided by an advertiser using GUI 400. Offer distribution facility 214 may be configured to deliver advertisement 500 to a plurality of users through any suitable means (e.g., through a SMS or MMS message). If desired, a user may then utilize information conveyed in advertisement 500 and/or select any links provided by advertisement 500 to consider the offer and choose to either submit or not submit an order for the product being offered for sale in advertisement 500.

In some examples, offer distribution facility 214 may be configured to identify, in association with grouping facility 218, a plurality of users based on one or more criteria and deliver the data representative of the offer to the identified plurality of users. For example, grouping facility 218 may group a plurality of users based on their association with a predefined user group, which may include any of the predefined user groups described herein. Using the information from grouping facility 218, offer distribution facility 214 may selectively deliver an offer to only users associated with the predefined user group.

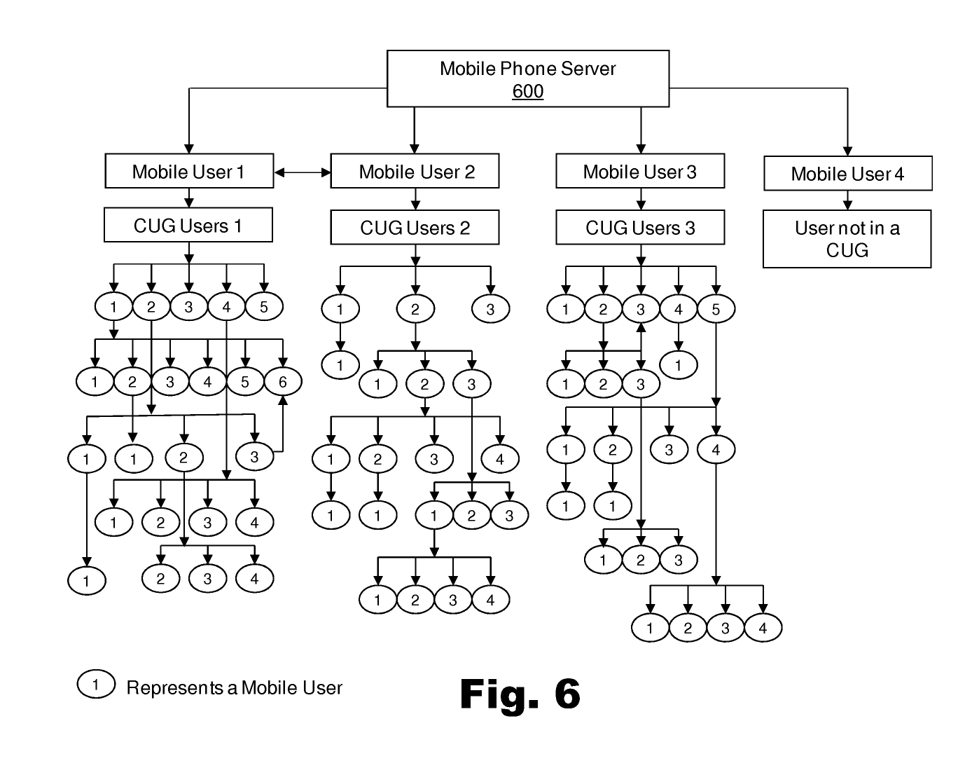

To help facilitate an understanding of selective distribution of an offer to users included in a predefined user group, FIG. 6 illustrates an exemplary mobile phone server 600 (or simply “mobile server 600”) configured to serve a plurality of mobile users (e.g., “mobile user 1 through “mobile user 4”) such as by distributing content to mobile devices associated with the mobile users. Each mobile user may be associated with one or more other mobile users (i.e., “CUG users”) through one or more CUGs. For example, mobile user 1 is illustrated as being associated with a plurality of CUG users 1. In particular, as illustrated in FIG. 6, mobile user 1 may be directly associated with five CUG users through a CUG. In addition, each of the five CUG users may be associated with one or more other CUG users through one or more other CUGs. Therefore, mobile user 1 may be indirectly associated with the one or more other CUG users. Hence, FIG. 6 illustrates mobile user 1 being associated—directly or indirectly—with twenty-three CUG users through a plurality of CUGs. This example is for illustrative purposes only. It will be recognized that a mobile user may be associated with any number of CUG users through any number of CUGs (e.g., a single CUG or a plurality of CUGs) as may serve a particular implementation. As further illustrated in FIG. 6, mobile user 1 may also be associated with mobile user 2 (who in turn may be associated with CUG users 2 through one or more CUGs), mobile user 3 may be associated with CUG users 3 through one or more CUGs, and mobile user 4 may not be associated with any CUG users.

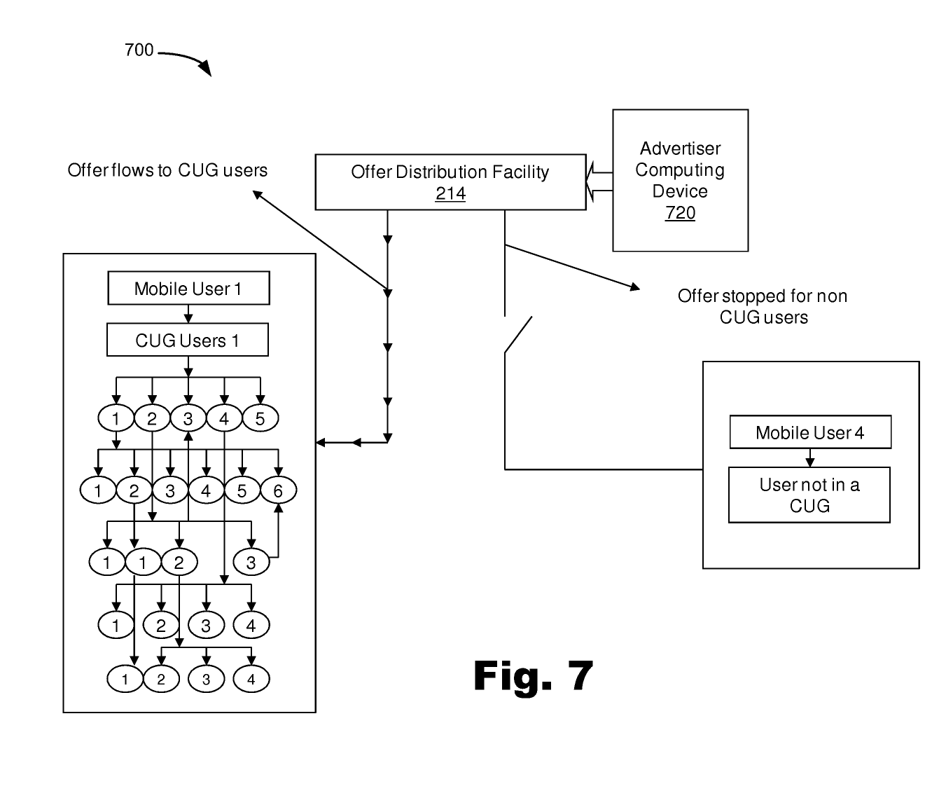

A particular strategic marketing campaign may target CUG users only. For example, FIG. 7 illustrates an exemplary implementation 700 of system 100 configured to target CUG users with an offer for sale of a product. As shown, in implementation 700, offer distribution facility 214 may receive data representative of an offer for sale of a product from an advertiser computing device 720. Advertiser computing device 720 may be associated with an advertiser desiring to market its product to CUG users only. Accordingly, the data received by offer distribution facility 214 may include instructions to distribute the offer only to CUG users. In response, offer distribution facility 214 may identify mobile user 1 as being associated with a plurality of CUG users and may deliver the offer to mobile user 1 and the associated CUG users. Offer distribution facility 214 may identify that mobile user 4 is not associated with any CUG user and may prevent the offer from being delivered to mobile user 4. In certain examples, grouping facility 218 may assist offer distribution facility 214 in the identification and grouping of the CUG users.

By targeting CUG users, or users associated with each other through any other predefined user group, an advertiser may harness social influence within the users to influence purchasing patterns, such as has been shown to occur within circles of friends, relatives, colleagues, etc. Thus, individual purchasing may be influenced by the group with which the individual is associated.

FIGS. 6 and 7 illustrate a marketing campaign targeting users associated with one or more CUGs for illustrative purposes only. Additional exemplary marketing campaigns may target users associated with any predefined user group or groups. Additional exemplary predefined user groups may include a social networking group, a professional networking group, a group of friends, a group of relatives, a group of professional colleagues, a group of mobile phone service users participating in a group mobile service plan, a group of mobile phone service users associated with each other through individual selections by each mobile service user of one or more other mobile service users as part of a mobile service plan (e.g., a mobile service user's selection of certain mobile service users that may be called free of charge and/or without counting toward a service usage threshold), etc.

Additionally or alternatively, the predefined user group may include users associated with a particular advertising platform. For example, an advertiser may wish to target users associated with a television service platform, but not users associated with other platforms (e.g., an Internet service platform). Thus, the offer may be selectively delivered only to access devices (e.g., set-top-box devices) associated with users of the television service platform.

In some examples, a marketing campaign may target users that have participated in a previous marketing campaign. For example, an advertiser (e.g., an electronics retailer) may wish to deliver an offer for sale of a product (e.g., a blue-ray disc player) to users that responded positively (e.g., users who submitted an order) in response to a previous marketing campaign (e.g., a previous campaign that offered high-definition televisions for purchase).

Returning to FIG. 3, in step 306, data representative of one or more orders for the product by one or more users may be received. For example, user interface facility 216 may receive data representative of the one or more orders from one or more access devices 136 associated with one or more users 138. The data representative of the one or more orders may be received by user interface facility 216 in any suitable manner.

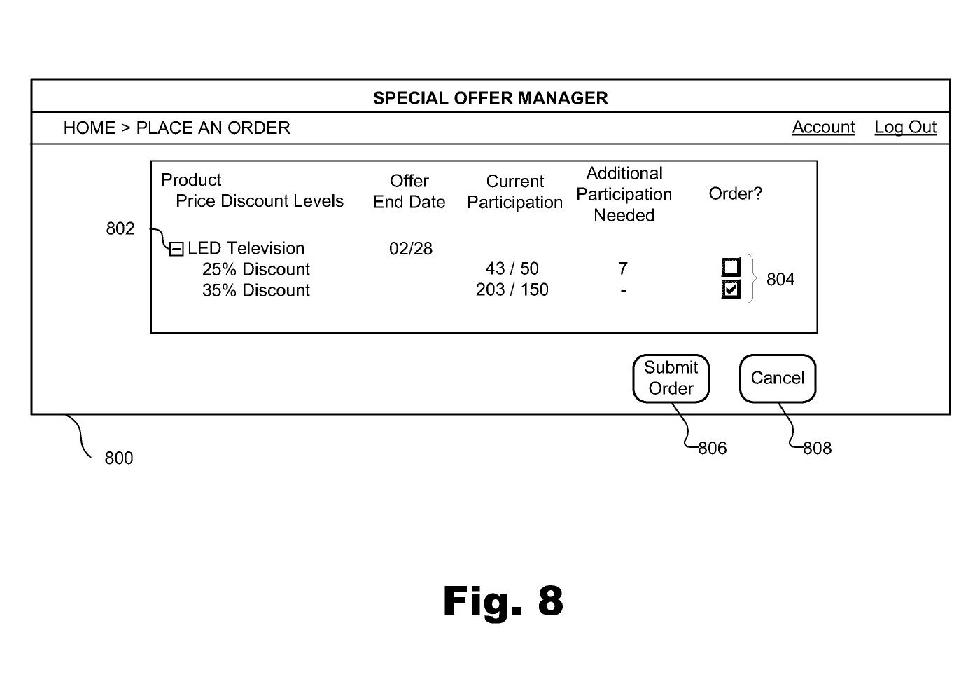

To illustrate, the data representative of the one or more orders may be received by way of a GUI provided by user interface facility 216. For example, a user responding to advertisement 500 (e.g., by clicking on a link provided in advertisement 500) may be directed to a GUI configured to facilitate the user's placement of an order for the product being offered by advertisement 500. FIG. 8 illustrates an exemplary GUI 800 that may facilitate submission of an order by the user for a product in response to an offer for sale of the product.

As shown in FIG. 8, GUI 800 may set forth the parameters and/or conditions of the offer, such as information 802 about the product being offered, the price discount levels being offered, the expiration date of the offer, the current participation, and the additional participation needed to satisfy the participation requirement. GUI 800 may also include selectable options (e.g., options 804, 806, and 808) configured to allow a user to select an offer, select one or more corresponding price discount levels, submit an order for the selected offer, and/or cancel an order. Accordingly, a user may utilize GUI 800 to submit an order for an offered product (e.g., an LED television) at one of the available price discounts (e.g., a 35% discount). GUI 800 is provided for illustrative purposes only. User interface facility 216 may be configured to receive data representative of one or more orders from one or more users in any other suitable manner.

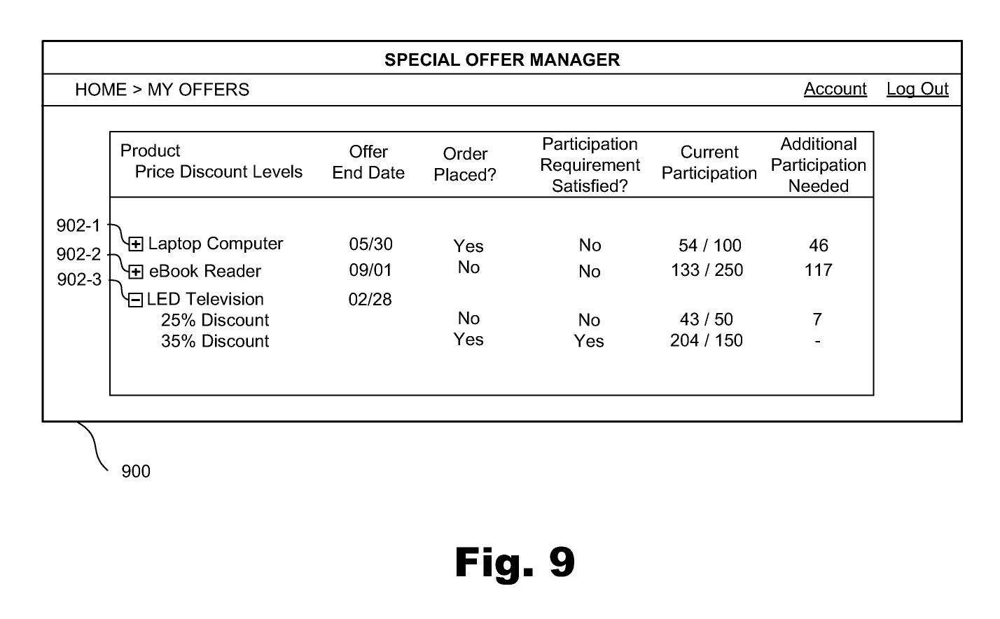

Additionally or alternatively, user interface facility 216 may be configured to provide a user with ongoing information regarding one or more offers available to the user. For example, user interface facility may deliver information to a user regarding the user's available offers in any suitable manner. FIG. 9 illustrates an exemplary GUI 900 that may be provided by user interface facility 216 to deliver information to a user regarding one or more offers currently available to the user, including offers to which the user has already responded by placing one or more orders. GUI 900 may be presented to the user in any suitable manner as may serve a particular implementation.

As shown in FIG. 9, information regarding offers 902-1 through 902-3 (collectively referred to herein as “offers 902”) currently available to the user may be displayed in GUI 900. The information may include names or descriptions of the products being offered through the offers 902, price discount levels specified by the offers 902, and any expiration dates associated with the offers 902. Information regarding the current status of each offer 902 may also be displayed in GUI 900. For example, information indicating how many users are participating in each offer 902, how many additional users are needed to participate before the conditions of each offer 902 are met, and an indication of whether the conditions of the offers 902 have already been met may be provided by way of GUI 900. Accordingly, a user may utilize GUI 900 to efficiently track information regarding one or more offers available to the user and/or one or more orders placed by the user.

GUI 900 is provided for illustrative purposes only. Data associated with one or more offers available to the user and/or orders placed by the user may be delivered to the user in any other suitable manner.

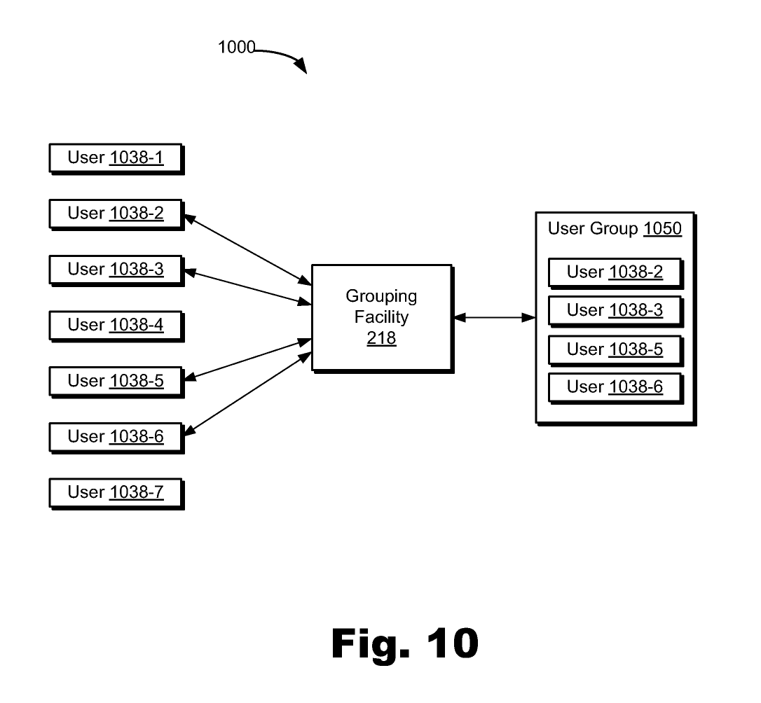

Returning to FIG. 3, in step 308, data representative of the one or more of the plurality of users may be grouped into a group based on the one or more orders and at least one of the price discount and the corresponding participation requirement. The data representative of the one or more of the plurality of users may be grouped by grouping facility 218 in any suitable manner. To illustrate, FIG. 10 shows an exemplary grouping 1000 of users 1038-1 through 1038-7 (referred to collectively herein as “users 1038”) into a user group 1050. Prior to the grouping, data representative of an offer may be delivered to users 1038. In response to the offer, users 1038-2, 1038-3, 1038-5, and 1038-6 may submit orders for the product offered for sale. Grouping facility may be configured to group data representative of users 1038-2, 1038-3, 1038-5, and 1038-6 into user group 1050 based on the orders and further based on one or more parameters associated with the offer. For example, the grouping may be based on the product being ordered, a price discount level selected by the users 1038-2, 1038-3, 1038-5, and 1038-6, a corresponding participation requirement, or any other suitable parameter of the offer. Data representative of user group 1050 may include a number of orders placed by the users 1038-2, 1038-3, 1038-5, and 1038-6 in user group 1050, a number of users in user group 1050, and/or any other data that may facilitate fulfillment of the orders (e.g., personal information, billing information, etc.). Grouping facility 218 may be configured to group any other data representative of users 1038-2, 1038-3, 1038-5, and 1038-6 in any other suitable manner and based on any other available information.

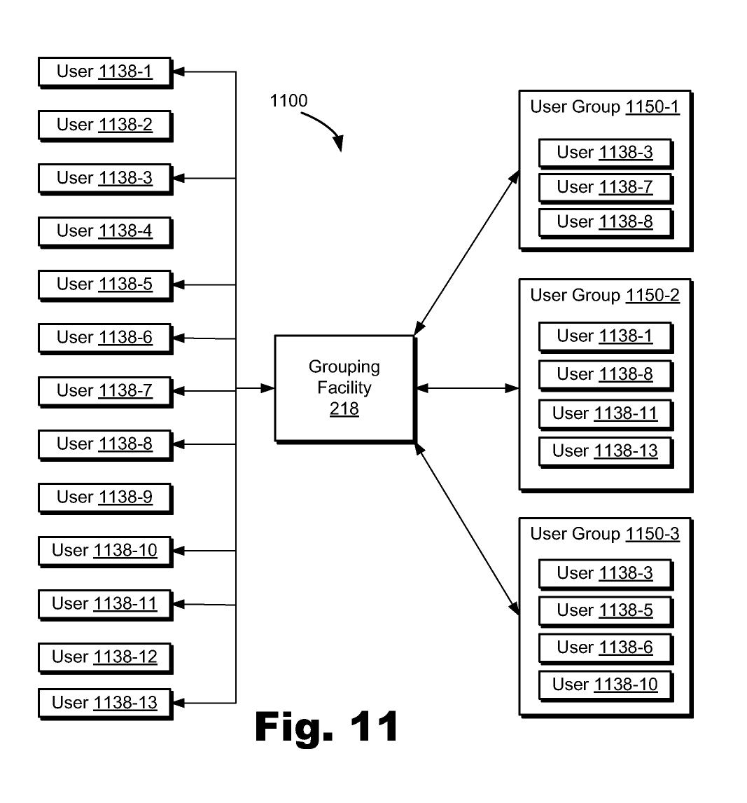

FIG. 10 illustrates grouping facility 218 grouping four users out of seven users into a single user group for illustrative purposes only. It will be appreciated that any number of users 1038 may be grouped into any number of user groups 1050 as may serve a particular implementation. For examples, FIG. 11 illustrates an exemplary grouping 1100 of data representative of one or more of a plurality of users 1138-1 through 1138-13 (collectively referred to herein as “users 1138”) into a plurality of user groups 1150-1 through 1150-3 (collectively referred to herein as “user groups 1150”) according to principles described herein. Prior to the grouping, a plurality of offers for sale of a plurality of products, each specifying one or more price discount levels and one or more corresponding participation requirements, may have been delivered to users 1138. In response to the offers, users 1138-1, 1138-3, 1138-5, 1138-6, 1138-7, 1138-8, 1138-10, 1138-11, and 1138-13 may each submit one or more orders. For example, each of users 1138-1, 1138-3, 1138-5, 1138-6, 1138-7, 1138-8, 1138-10, 1138-11, and 1138-13 may submit an order for a single product, multiple orders for multiple products, multiple orders for a single product, multiple orders at different price discount levels for a single product, etc. Grouping facility 218 may group data representative of users 1138-1, 1138-3, 1138-5, 1138-6, 1138-7, 1138-8, 1138-10, 1138-11, and 1138-13 into user groups 1150 based on the orders, the ordered products, the specified price discount levels, the corresponding participation requirements, and/or any other parameters of the offers. Because each of users 1138-1, 1138-3, 1138-5, 1138-6, 1138-7, 1138-8, 1138-10, 1138-11, and 1138-13 may respond to the available offers by ordering a plurality of different products and/or by specifying a plurality of price discount levels of interest to the user, each user submitting an order may be grouped into one or a plurality of user groups 1150.

For illustrative purposes, users 1138-3, 1138-7, and 1138-8 may submit orders for a first product (e.g., an mp3 player) at a first price discount level (e.g., a 20% discount). User 1138-8 may also, along with users 1138-1, 1138-11, and 1138-13, submit orders for the first product at a second price discount level (e.g., a 30% discount). User 1138-3 may also, along with users 1138-5, 1138-6, and 1138-10, submit orders for a second product (e.g., a smartphone). Accordingly, grouping facility 218 may group data representative of users 1138-3, 1138-7, and 1138-8 into user group 1150-1, data representative of users 1138-1, 1138-8, 1138-11, and 1138-13 into user group 1150-2, and data representative of users 1138-3, 1138-5, 1138-6, and 1138-10 into user group 1150-3.

The examples illustrated in FIGS. 10 and 11 are illustrative only. Grouping of one or more users into a group based on one or more orders and on at least one of price discount and corresponding participation requirements may be achieved in any other suitable manner.

Returning to FIG. 3, in step 310, a determination may be made as to whether the group satisfies the participation requirement. For example, analysis facility 220 may determine whether the group satisfies the participation requirement in any suitable manner. In some examples, analysis facility 220 may compare the group (e.g., user group 1050) to the corresponding participation requirement to determine whether the group represents enough orders and/or users to satisfy the participation requirement. The determination can be made dynamically throughout the course of a marketing campaign or statically at the expiration of an offer.

In step 312, in response to a determination that the group satisfies the participation requirement, data representative of the group may be delivered to advertiser subsystem for use in fulfillment of the orders. For example, advertiser interface facility 212 may provide the data representative of the group to advertiser subsystem 120 in any suitable manner and including any information that may be used by advertiser to fulfill the orders placed by the users within the user group.

Additionally or alternatively, analysis facility 220 may be configured to analyze and compare a plurality of groups that each satisfy their respective participation requirements and dynamically move users among the satisfying groups. To illustrate, in response to an offer specifying a plurality of price discount levels and corresponding participation requirements, a user may submit an order indicating an interest in purchasing the product at more than one price discount level. For example, and referring again to FIG. 8, a user may submit an order for a product (e.g., an LED television) after selecting more than one price discount level (e.g., 25% and 35%) to indicate an interest in purchasing the product at the lower discount level (e.g., 25%) in case the participation requirement corresponding to the higher discount level (e.g., 35%) is not satisfied. As a result, data representative of the user may be grouped into two separate groups based on the price discount levels. If only one of the groups satisfies its corresponding participation requirement, then the order may be fulfilled in accordance with the price discount level associated with the satisfying group. However, if both groups satisfy the corresponding participation requirements, analysis facility 220 may determine which price discount level the user prefers. In some examples, the analysis facility 220 may automatically place the user in the group representing the higher or highest discount level. Additionally or alternatively, upon submitting an order, a user may provide a prioritization of price discount levels to assist the analysis facility 220 in its determination.

If the analysis facility 220 determines that a group does not satisfy the corresponding participation requirement, the analysis facility 220 may be configured to initiate a negotiation between the users in the group and the advertiser associated with the offer in accordance with a predefined negotiation heuristic. To illustrate, an advertiser may offer a product (e.g. a tax preparation service) at a discounted rate (e.g., a $50 discount) conditioned on a participation requirement of one hundred users. In response to the offer, seventy-five users may submit orders for the product and data representative of the seventy-five users may be grouped into a user group. When the analysis facility 220 determines that the user group does not satisfy the participation requirement, the advertiser may be contacted to initiate a negotiation of another discount for the seventy-five users. The advertiser may indicate that it would be willing to provide the product for a negotiated price (e.g., a $40 discount) for the users in the user group. The negotiated price may be offered to the users in the group and an indication may be received from the users in the group as to whether they would be willing to purchase the product at the negotiated price. If the number of users willing to purchase the product at the negotiated price is acceptable to the advertiser, the purchase can be finalized at the negotiated price. If not, the negotiation may continue until a mutually agreeable price discount level is reached. Hence, despite the user group failing to satisfy the participation requirement, strategic marketing subsystem 110 may facilitate a mutually agreeable negotiated purchase between the user group and the advertiser based on the number of users indicating their willingness to purchase the product at the offered price.

In certain embodiments, analysis facility 220, user interface facility 216, and/or advertiser interface facility 212 may provide a notification to the users in the group and/or an associated advertiser once the participation requirement has been met. The notification may be sent in any suitable manner.

In some examples, tracking information may be provided to users and/or advertisers to allow the users and/or advertisers to track orders and/or marketing campaigns. For example, a GUI (e.g., GUI 900) may be provided to a user to allow the user to track information related to the user's orders and/or available offers. As a result, user may be provided with up-to-date information regarding the offers and whether the conditions of each offer are met.

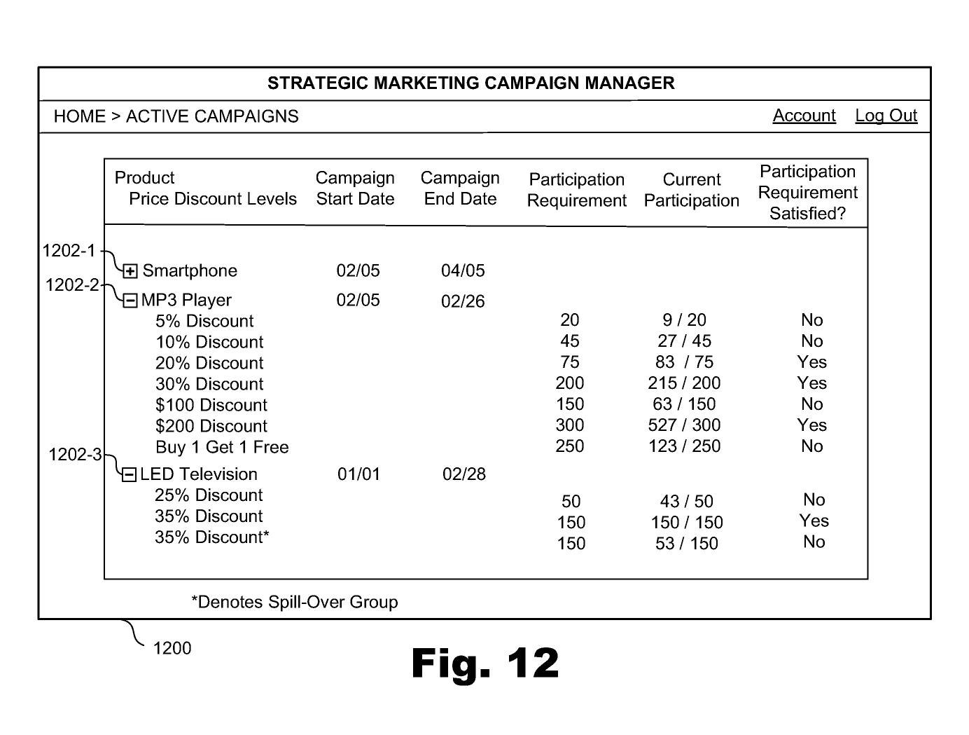

Similarly, as shown in FIG. 12, advertiser interface facility 212 may provide a GUI 1200 to an advertiser to allow the advertiser to track information related to offers 1202-1 through 1202-3 (collectively referred to herein as “offers 1202”) made available by the advertiser. For example, information regarding what products the advertiser is offering for sale, the price discount levels associated with each offer and/or product, one or more dates (e.g., expiration dates) associated with the offers 1202, the participation requirements of each price discount level, how many orders have already been placed, how many additional orders need to be received to satisfy the participation requirements, and/or any other information related to an advertiser's offers 1202 may be provided to the advertiser by way of GUI 1200. Accordingly, an advertiser may utilize GUI 1200 to track the current status and success or failure of its offers 1202.

Analysis facility 220 may also be configured to analyze, track, and provide an advertiser with additional data regarding an offer for sale and an associated marketing campaign. Examples of additional tracking data may include, but are not limited to, impression counts indicating numbers of times that an offer and/or associated advertisement has been distributed, requested, played back, recorded, interacted with, and/or otherwise experienced by one or more users, impression counts by designated marketing areas, duration metrics indicating durations of time that an offer and/or associated advertisement has been played back, recorded, and/or displayed, a number of total user across platforms (e.g., platforms 130), counts for offers and/or associated advertisements distributed per recipient (e.g., per access device 136), offer and/or advertisement viewing duration metrics, total offers and/or advertisements viewed by time duration and/or mode (e.g., fast forward, standard play, rewind, etc.), timestamp information (e.g., timestamps for duration and behavior of offers and/or advertisements), ad selection counts (e.g., number and/or time of “clicks”), click-stream behavior data (e.g., source and counts of prior clicks), data identifying video environments from which clicks originated, breakout data indicating after-the-click behavior, and/or any other data descriptive of offer and/or advertisement distribution performance.

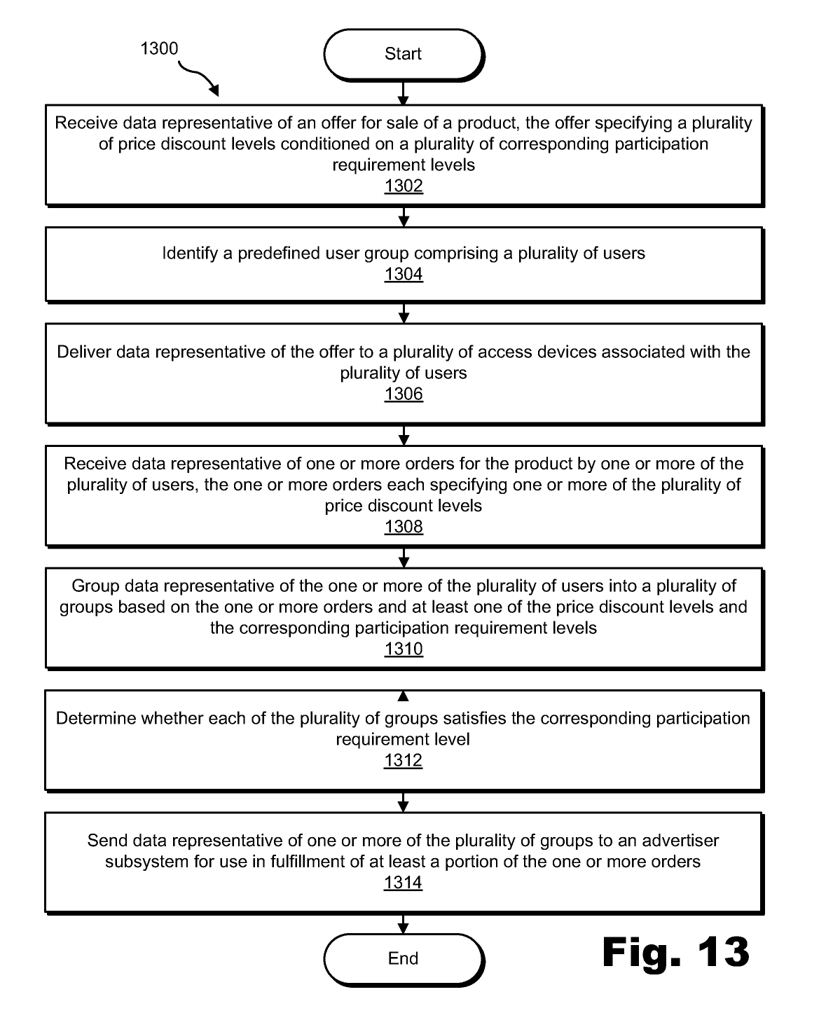

FIG. 13 illustrates another exemplary strategic marketing method 1300. While FIG. 13 illustrates exemplary steps according to one embodiment, other embodiments may omit, add to, reorder, and/or modify any of the steps shown in FIG. 13. One or more steps shown in FIG. 13 may be performed by any component or combination of components of system 100.

In step 1302, data representative of an offer for sale of a product may be received. The offer may specify a plurality of price discount levels conditioned on a plurality of corresponding participation requirement levels. The data representative of the offer may be received in any of the ways described herein.

In step 1304, a predefined user group comprising a plurality of users may be identified. The predefined user group may be identified in any of the ways described herein, including based on one or more parameters of the offer.

In step 1306, data representative of the offer may be delivered to a plurality of access devices associated with the plurality of users. The data representative of the offer may be delivered in any of the ways described herein.

In step 1308, data representative of one or more orders for the product by one or more of the plurality of users may be received, the one or more orders each specifying one or more of the plurality of price discount levels. The data representative of the one or more orders may be received in any of the ways described herein.

In step 1310, data representative of the one or more users may be grouped into a plurality of groups based on the one or more orders and on at least one of the price discount levels and the corresponding participation requirements of the offer. The data representative of the one or more users may be grouped in any of the ways described herein.

In step 1312, a determination may be made as to whether each of the plurality of groups satisfies the corresponding participation requirements. The determination may be made in any of the ways described herein.

In step 1314, data representative of one or more of the plurality of groups may be sent to an advertiser subsystem for use in fulfillment of at least a portion of the one or more orders. The data representative of the one or more of the plurality of groups may be sent in any of the ways described herein.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software), or combinations of computer-implemented instructions and hardware, configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

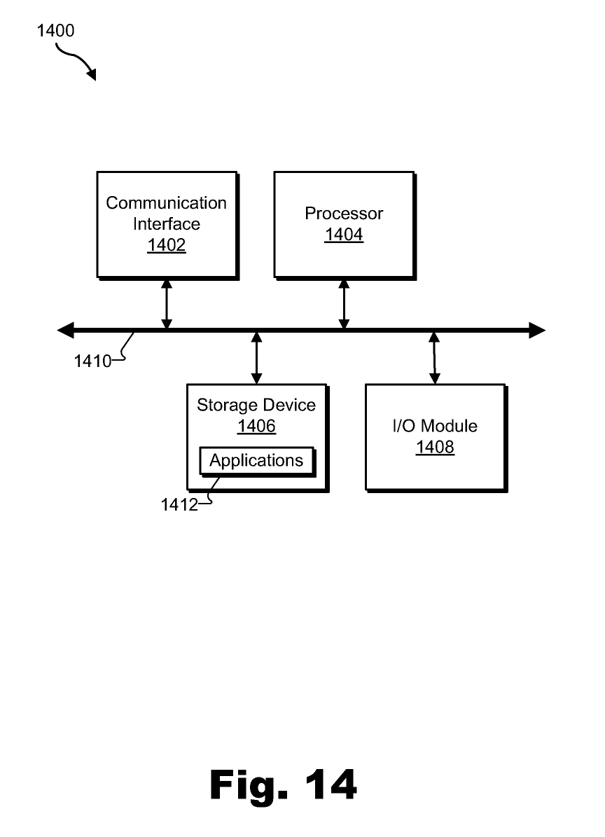

FIG. 14 illustrates an exemplary computing device 1400 that may be configured to perform one or more of the processes described herein. As shown in FIG. 14, computing device 1400 may include a communication interface 1402, a processor 1404, a storage device 1406, and an input/output (“I/O”) module 1408 communicatively connected via a communication infrastructure 1410. While an exemplary computing device 1400 is shown in FIG. 14, the components illustrated in FIG. 14 are not intended to be limiting. Additional or alternative components may be used in other embodiments. Components of computing device 1400 shown in FIG. 14 will now be described in additional detail.

Communication interface 1402 may be configured to communicate with one or more computing devices. Examples of communication interface 1402 include, without limitation, a wired network interface (such as a network interface card), a wireless network interface (such as a wireless network interface card), a modem, and any other suitable interface. In at least one embodiment, communication interface 1402 may provide a direct connection between marketing subsystem 110, advertiser subsystem 120, advertising platform subsystems 132, and/or access devices 136 via a direct link to a network, such as network 140 of FIG. 1. Communication interface 1402 may additionally or alternatively provide such a connection through, for example, a local area network (such as an Ethernet network), a personal area network, a telephone or cable network, a satellite data connection, a dedicated URL, or any other suitable connection. Communication interface 1402 may be configured to interface with any suitable communication media, protocols, and formats, including any of those mentioned above.

Processor 1404 generally represents any type or form of processing unit capable of processing data or interpreting, executing, and/or directing execution of one or more of the instructions, processes, and/or operations described herein. Processor 1404 may direct execution of operations in accordance with one or more applications 1412 or other computer-executable instructions such as may be stored in storage device 1406 or another computer-readable medium.

Storage device 1406 may include one or more data storage media, devices, or configurations and may employ any type, form, and combination of data storage media and/or device. For example, storage device 1406 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1406. For example, data representative of one or more executable applications 1412 (which may include, but are not limited to, one or more of the software applications described herein) configured to direct processor 1404 to perform any of the operations described herein may be stored within storage device 1406. In some examples, data may be arranged in one or more databases residing within storage device 1406.

I/O module 1408 may be configured to receive user input and provide user output and may include any hardware, firmware, software, or combination thereof supportive of input and output capabilities. For example, I/O module 1408 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1408 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1408 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1400. For example, one or more applications 1412 residing within storage device 1406 may be configured to direct processor 1404 to perform one or more processes or functions associated with advertiser interface facility 212, offer distribution facility 214, user interface facility 216, grouping facility 218, and/or analysis facility 220. Likewise, storage facility 222 may be implemented by or within storage device 1406.

The components of strategic marketing subsystem 110 may be implemented by computing device 1400 or a combination of computing devices, such as a media content processing device, a server device (e.g., an application server, video server, web server, etc.), video hub office equipment, a set-top box, a communications device, a mobile device (e.g., a mobile phone device), a handheld device, a personal computer, a phone device, a personal-digital assistant device, a gaming device, a digital video recording (“DVR”) device (e.g., a personal video recording (“PVR”) device), a television device, and/or any media content access and/or distribution device configured to perform one or more of the advertising platform processes and/or operations described herein.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
receiving, by a strategic marketing subsystem from an advertiser subsystem, data representative of an offer for sale of a product, the offer specifying a price discount conditioned on a corresponding participation requirement;
delivering, by the strategic marketing subsystem, data representative of the offer to a plurality of access devices associated with a plurality of users;
receiving, by the strategic marketing subsystem, data representative of one or more orders for the product by one or more of the plurality of users;
grouping, by the strategic marketing subsystem, data representative of the one or more of the plurality of users into a group based on the one or more orders and on at least one of the price discount and the corresponding participation requirement;
determining, by the strategic marketing subsystem, whether the group satisfies the participation requirement; and
sending, by the strategic marketing subsystem and in response to a determination that the group satisfies the corresponding participation requirement, data representative of the group to the advertiser subsystem for use in fulfillment of the one or more orders.

2. The method of claim 1, wherein the plurality of access devices includes access devices associated with a plurality of distinct, heterogeneous advertising platforms.

3. The method of claim 2, wherein the plurality of distinct, heterogeneous advertising platforms comprises a mobile phone service platform, a television service platform, and an internet service platform.

4. The method of claim 1, wherein the delivering of the data representative of the offer to the plurality of access devices associated with the plurality of users further comprises identifying, by the strategic marketing subsystem, the plurality of users based on one or more criteria.

5. The method of claim 4, further comprising receiving, by the strategic marketing subsystem from the advertiser subsystem, data representative of the one or more criteria.

6. The method of claim 4, wherein the one or more criteria comprise an association of each user within the plurality of users with a predefined user group.

7. The method of claim 6, wherein the predefined user group comprises a group of mobile phone service users associated with each other through at least one of a closed user group, a group mobile phone service plan, and a mobile phone service user's selection of one or more other mobile phone service users.

8. The method of claim 6, wherein the predefined user group comprises at least one of a social networking group, a professional networking group, a group of friends, a group of relatives, a group of professional colleagues, a group of users associated with a particular advertising platform, and a group of users associated with a prior promotional campaign.

9. The method of claim 1, wherein the offer for sale of the product specifies a plurality of price discount levels conditioned on a plurality of corresponding participation requirement levels, wherein the price discount is included in the plurality of price discount levels and the corresponding participation requirement is included in the plurality of corresponding participation requirement levels.

10. The method of claim 9, wherein each of the one or more orders for the product specifies a selection of one or more of the plurality of price discount levels, and the grouping comprises grouping data representative of the one or more of the plurality of users into a plurality of groups based on the one or more orders and on at least one of the plurality of price discount levels and the plurality of corresponding participation requirement levels, and wherein the method further comprises:
determining, by the strategic marketing subsystem, whether each group within the plurality of groups satisfies the participation requirement level corresponding to the group;
identifying, by the strategic marketing subsystem and in response to a determination that multiple groups within the plurality of groups satisfy the corresponding participation requirement levels, which group of the multiple groups corresponds to the greatest price discount level; and
sending, by the strategic marketing subsystem, data representative of the identified group to the advertiser subsystem for use in fulfillment of the one or more orders associated with the identified group.

11. The method of claim 1, further comprising facilitating, by the strategic marketing subsystem and in response to a determination that the group does not satisfy the corresponding participation requirement, a negotiation of a purchase of the product by the one or more of the plurality of users for a negotiated price in accordance with a predefined negotiation heuristic.

12. The method of claim 1, further comprising delivering, by the strategic marketing subsystem and in response to the determination that the group satisfies the corresponding participation requirement, data representative of a notification to one or more of the access devices associated with the one or more users included in the group, the notification indicating that the corresponding participation requirement has been satisfied.

13. The method of claim 1, further comprising providing, by the strategic marketing subsystem, information related to the offer to at least one of the advertiser subsystem and one or more of the plurality of access devices associated with the plurality of users, the information specifying a number of orders received in relation to the corresponding participation requirement.

14. The method of claim 1, further comprising grouping, by the strategic marketing subsystem and in response to the determination that the group satisfies the corresponding participation requirement, data representative of one or more of the users exceeding the corresponding participation requirement into another group.

15. The method of claim 1, embodied as computer-executable instructions on at least one tangible computer-readable medium.

16. A method comprising:
receiving, by a strategic marketing subsystem from an advertiser subsystem, data representative of an offer for sale of a product, the offer specifying a plurality of price discount levels, each price discount level within the plurality of price discount levels conditioned on a corresponding participation requirement level within a plurality of participation requirement levels;
identifying, by the strategic marketing subsystem, a predefined user group comprising a plurality of users;
delivering, by the strategic marketing subsystem, data representative of the offer to a plurality of access devices associated with the plurality of users included in the predefined user group;
receiving, by the strategic marketing subsystem, data representative of one or more orders for the product by one or more of the plurality of users, each order within the one or more orders specifying one or more of the plurality of price discount levels;
grouping, by the strategic marketing subsystem, data representative of the one or more of the plurality of users into a plurality of groups based on the one or more orders and on at least one of the plurality of price discount levels and the plurality of participation requirement levels, each group within the plurality of groups corresponding to one of the plurality of price discount levels and one of the plurality of participation requirement levels;
determining, by the strategic marketing subsystem, whether each of the plurality of groups satisfies the participation requirement level corresponding to the group;
determining, by the strategic marketing subsystem, which of the satisfying groups corresponds to the highest price discount level; and
sending, by the strategic marketing subsystem, data representative of the satisfying group corresponding to the highest price discount level to the advertiser subsystem for use in fulfillment of the order.

17. The method of claim 16, further comprising regrouping the data representative of the one or more of the plurality of users into the plurality of groups based on the determination as to which of the satisfying groups corresponds to the highest price discount level.

18. The method of claim 16, further comprising receiving, by the strategic marketing subsystem from the one or more of the plurality of users, data representative of a prioritization of the plurality of price discount levels.

19. The method of claim 16, wherein the predefined user group comprises a group of mobile phone service users associated with each other through at least one of a closed user group, a group mobile phone service plan, and a mobile phone service user's selection of one or more other mobile phone service users.

20. The method of claim 16, wherein the predefined user group comprises at least one of a social networking group, a professional networking group, a group of friends, a group of relatives, a group of professional colleagues, a group of users associated with a distinct, heterogeneous advertising platform, and a group of users that participated in a prior promotional campaign.

21. The method of claim 16, further comprising receiving, by the strategic marketing subsystem from the advertiser subsystem, data representative of one or more criteria to be used by the strategic marketing subsystem to identify the predefined user group.

22. A system comprising:
an advertiser interface facility configured to receive, from an advertiser subsystem, data representative of an offer for sale of a product, the offer specifying a price discount conditioned on a corresponding participation requirement;
an offer distribution facility communicatively coupled to the advertiser interface facility and configured to deliver data representative of the offer to a plurality of access devices associated with a plurality of users;
a user interface facility communicatively coupled to the offer distribution facility and configured to receive data representative of one or more orders for the product by one or more of the plurality of users;
a grouping facility communicatively coupled to the user interface facility and configured to group data representative of the one or more of the plurality of users into a group based on the one or more orders and on at least one of the price discount and the corresponding participation requirement; and
an analysis facility communicatively coupled to the grouping facility and configured to determine whether the group satisfies the participation requirement; and
wherein the advertiser interface facility is further configured to send data representative of the group to the advertiser subsystem for use in fulfillment of the one or more orders in response to a determination that the group satisfies the corresponding participation requirement.
